(19) United States
(12) Patent Application Publication
(10) Pub. No.: US 2024/0423358 A1
(43) Pub. Date: Dec. 26, 2024

(54) DETACHABLE ONE PIECE SPRING HANDLES FOR CHAFING PANS AND TABLE CASTERS

(71) Applicant: Get-A-Grip Chafing Pans, LLC., Gibsonia, PA (US)

(72) Inventors: Joseph L. Leonard, Gibsonia, PA (US); Lois Leonard, Gibsonia, PA (US)

(21) Appl. No.: 18/777,159

(22) Filed: Jul. 18, 2024

Related U.S. Application Data
(63) Continuation-in-part of application No. 16/795,330, filed on Feb. 19, 2020, now abandoned.
(60) Provisional application No. 62/807,353, filed on Feb. 19, 2019.

(51) Int. Cl. A47B 13/02; F16F 1/26

(52) U.S. Cl. CPC A47B 13/021; F16F 1/26

(57) ABSTRACT

A caterer buffet table conversion kit comprises detachable one piece spring handles for transport and exchange of chafing dishes, and table casters. The components of the kit have utility individually. The handles are each formed from a one piece spring steel and include a semi-cylindrical grip, an upper and a lower leaf with the lower having a spring forming member facilitating the engagement of the chafing pan between the leafs. Each caster may be a low profile caster which includes a caster assembly and a tubular table coupling bracket coupled thereto and configured to receive a conventional table leg therein. The bracket is offset from a caster wheel or caster ball and configured to receive the table leg wherein a terminal end of the table leg is positioned vertically below the center of the caster wheel or caster ball to minimize the height of the table top.

### RELATED APPLICATIONS

The present application is a continuation in part of U.S. patent application Ser. No. 16/795,330 filed Feb. 19, 2020, and which published as U.S. publication 2020-0262240 on Aug. 20, 2020, which application and publication are incorporated herein by reference. U.S. patent application Ser. No. 16/795,330 claims priority to U.S. Provisional Patent Application Ser. No. 62/807,353 entitled “Detachable One Piece Spring Handles for Chafing Pans and Low Profile Table Caster” filed Feb. 19, 2019.

### BACKGROUND OF THE INVENTION

### 1. Field of the Invention

The invention relates to the field of catering apparatuses, and in particular to a caterer buffet table conversion kit comprising detachable one piece spring handles for chafing pans to assist in the manual transport and exchange of chafing dishes, and a set of either low profile or straight wheel table casters, and to the components of this kit individually.

### 2. Background Information

Chafing pans, which are also referred to as chafing dishes, food pans, serving pans, steam tables, and buffet pans (collectively referred to herein as chafing pans), are widely used for buffet-type food service, serving various kinds of hot and cold foods. Such chafing pans, when serving hot foods, typically are used in an assembly which includes a supporting water pan supported by an open frame bracing structure. One or more heat sources, such as steno burners, are placed below the water pan to heat the water in the pan. A chafing pan is supported by the water pan, typically above the level of the water. A lid is often provided to cover the chafing pan. Typically, both the water pan and the chafing pan will include an outwardly extending peripheral rim at an upper portion thereof. The peripheral rim of the water pan engages the open frame bracing structure to support the water pan. In a similar fashion, the peripheral rim of the chafing pan engages the peripheral rim of the water pan to support the chafing dish.

Representative examples of this construction are found in U.S. Pat. Nos. 5,045,672, 5,347,979 and 5,517,903 and 5,676,276. It is also possible to utilize the chafing pans and the open frame bracing structure without the intervening water pan, such as for food dishes served and maintained at room temperature. In this configuration, the chafing pan may be supported directly of the open frame bracing structure. For cold or chilled dishes the water pan can be used to support ice to cool the chafing pan without contacting the food

The chafing pans must be removed from the assembly periodically for various reasons. For instance, chafing pans must be removed and replaced to replenish the food in the chafing dish assembly, and must be removed to clean the chafing pans.

Permanently attached handles have been used in chafing pans and in other nested cookware such as draining baskets or strainers as shown in U.S. Pat. Nos. 2,588,614 and 4,106,486. U.S. Pat. No. 925,781 discloses a steamer arrangement with integral handles to facilitate handling. U.S. Pat. No. 6,705,210 provides a very effective attached handle solution and this design, in practice, may represent a preferable solution for roll top chafing dishes as they are known in the art. U.S. Pat. No. 7,611,178 provides a more complex pan lifting implement. U.S. Pat. No. 6,721,996 provides another chafing dish handle solution.

The conventional chafing pans are typically constructed with a peripheral rim being either a planar flange having a down-turned outer edge or a planar ledge having an outwardly extending portion which rests on and provides an engagement surface for the water pan in which the chafing pan is placed.

U.S. Pat. No. 5,511,467 discloses a chafing dish handling frame formed from cylindrical steel of a shape and size for surrounding a chafing dish under its lateral flange. The frame includes two handles positioned so as not to interfere with proper seating of the pan in the receptacle hole in the steam table. One embodiment of the pan handling device includes lid/pan clamps for securing the pan handling device to a steam table pan as well as for securing a pan lid to a pan such as when food is to be stored in a pan. This solution does not adequately address pan storage or frame attachment.

U.S. Pat. Nos. 3,112,948 and 3,179,287 disclose special attachable chafing dish handles. U.S. Pat. No. 6,092,670 discloses separable handles for manipulating a steam pan.

All of the above identified patents are incorporated herein by reference as they clearly supply information regarding the conventional construction of chafing dish stands and pans and the like as well as identifying the shortcomings of the state of the art. As evidenced in this prior art there is a need for efficient and effective chafing pan handle solutions.

Caterers often set up and take down tables. Casters can make moving tables around to a desired location significantly easier. Conventional casters added to existing table legs can raise the height of the table noticeably and make the use of the tables unhelpful or impractical as the table height may become uncomfortable to users with associated chairs or the height is unwieldy for servicing. There is a need in the art for effective casters that can be added to conventional tables without unduly raising the height of the table. Additionally there remains a need for casters that can be quickly added and removed from tables.

### SUMMARY OF THE INVENTION

One aspect of the present invention is to provide a caterer buffet table conversion kit comprising detachable one piece spring handles for chafing pans to assist in the manual transport and exchange of chafing dishes, and a set of low profile table casters. The components of the caterer buffet table conversion kit have utility individually. The caterer buffet table conversion kit according to one aspect of the invention provides A) a pair of detachable one piece spring handles, wherein each one piece spring handle includes i) a semi-cylindrical grip; ii) an upper leaf formed as an L shaped member extending from the semi-cylindrical grip with a body member extending from the semi-cylindrical grip to a transition member and terminating in an end member which is substantially perpendicular to the body member; and iii) a lower leaf having a body member extending from the semi-cylindrical grip with a body member immediately adjacent the upper leaf body member, and a spring forming member that is configured to facilitate the engagement of the chafing pan between the upper and lower leaf; and b) a set of casters of one of four straight quick attaching casters or four low profile casters wherein each low profile caster includes i) a caster assembly including one of a wheel on an axle or a caster ball, and with caster locks to secure a caster and table in place; and ii) a tubular table coupling bracket coupled to the caster assembly and configured to receive a conventional table leg therein, wherein the tubular table coupling bracket is offset from the caster wheel or caster ball and configured to receive the table leg therein such that a terminal end of the table leg is positioned vertically below the center of the caster wheel or caster ball to minimize the height introduced to the table top by the use of the caster.

The chafing pan handles according to the present invention solves the difficulties inherent in prior art chafing pan handle solutions for detachable handles by providing a detachable one piece spring handle configuration desirable in the art. The chafing pan spring handles of the present invention allows a safe, efficient, and professional-appearing exchange and serving of food in the chafing pan.

Detachable chafing pan handles includes a pair of detachable one piece spring handles, wherein each one piece spring handle is formed from a one piece spring steel. Each one piece spring handle includes a semi-cylindrical grip, and upper leaf and a lower leaf. The upper leaf is a general L shaped member extending from the semi-cylindrical grip with a body member extending from the semi-cylindrical grip to an arcuate transition member and terminating in an end member which is substantially perpendicular to the body member. The lower leaf has a body member extending from the semi-cylindrical grip with a body member immediately adjacent the upper leaf body member, a bump-out member extends from the lower leaf body member and is extending away from the upper leaf body member, an arcuate nose member extends from the bump out member and is adjacent the upper leaf transition member, and the lower leaf terminates in an end member which is positioned to angle away from the upper leaf end member.

The low profile caster of the set of casters comprise a caster assembly including one of a wheel on an axle or a caster ball, and with caster locks to secure a caster and table in place; and a tubular table coupling bracket coupled to the caster assembly and configured to receive a conventional table leg therein, wherein the tubular table coupling bracket is offset from the caster wheel and configured to receive the table leg therein such that the terminal end of the table leg is positioned vertically below the center of the caster wheel to minimize the height introduced to the table top by the use of the caster.

### BRIEF DESCRIPTION OF THE DRAWINGS

FIG. 1A is a schematic side elevational view of a low profile caster according to one aspect of the present invention.

FIG. 1B is a schematic side elevation view of a straight wheel caster according to one aspect of the invention.

FIG. 2 is a perspective view of a detachable chafing pan handle in accordance with one aspect of the present invention;

FIG. 3 is an elevational side view of the detachable chafing pan handle of FIG. 2.

FIG. 4 is an end perspective view of two detachable chafing pan handles of FIG. 2, shown formed of separate material thickness.

FIG. 5 is a top and bottom perspective views of respective detachable chafing pan handles of FIG. 2.

### DESCRIPTION OF THE PREFERRED EMBODIMENTS

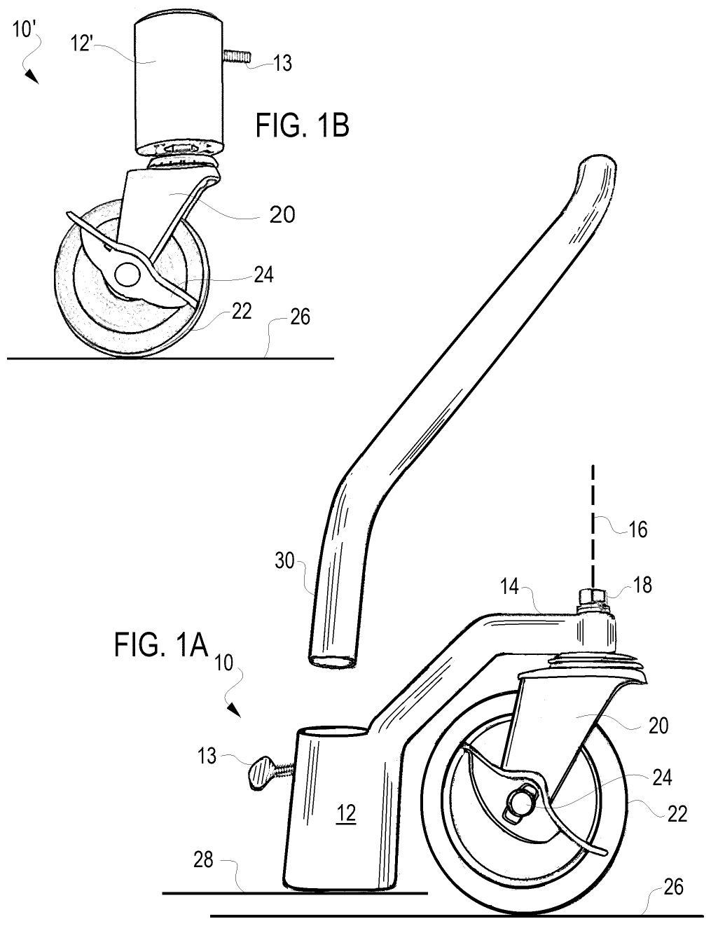

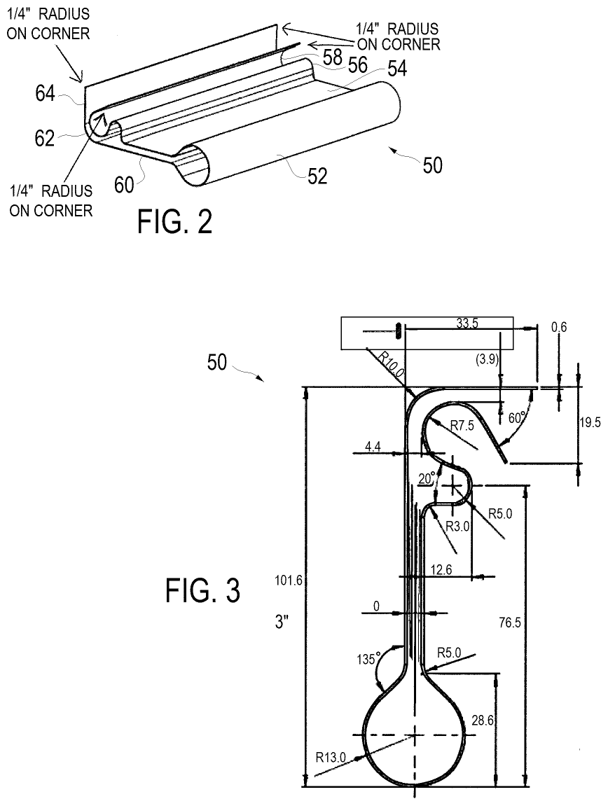

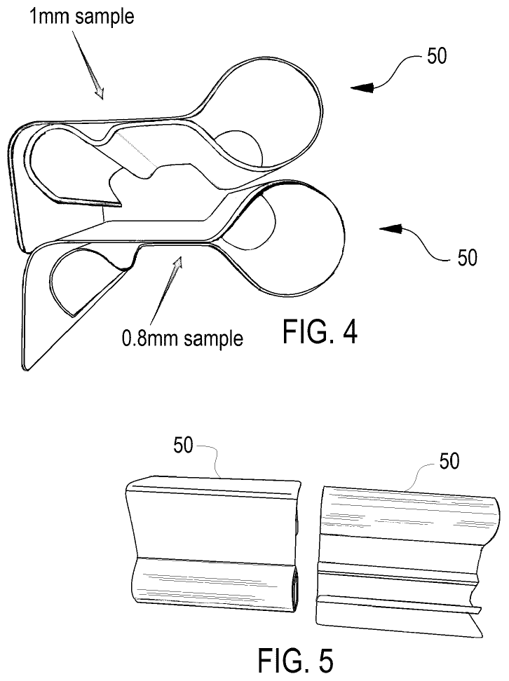

In summary, the present invention relates to caterer buffet table conversion kit comprising a pair of detachable one piece spring handles 50, shown in FIGS. 2-5, for chafing pans (not shown) to assist in the manual transport and exchange of chafing dishes, and a set of casters such as four low profile table casters 10, one of which is shown in FIG. 1A, for a buffet table (one leg 30 of which is shown in FIG. 1A), or straight table casters 10′, one of which is shown in FIG. 1B, also for a buffet table (one leg 30 of which is shown in FIG. 1A). Chafing pans, chafing dishes, water pans may all be used interchangeably herein and are known in the art. The components of the caterer buffet table conversion kit, namely the pair of detachable one piece spring handles 50 and the set of four low profile table casters 10, have utility individually, but are combined to form a table conversion kit mainly for caterers. Further highlighting the background suggested above, caterers are often required to use the tables at a given venue, and the tables are not always mobile. Adding casters to an existing table can make it far easier to move for set up and or take down, particularly of a buffet table. In many venues the buffet tables, and sometimes other tables, is/are moved to allow space for other activities (e.g., the dance floor), and casters can make the process much speedier and events run much more smoothly.

### Low Profile Caster 10

In some implementation, conventional casters will raise the height of the standard table to undesirable and less workable heights, particularly for tables that will require people to sit at them. For seated use of a table with conventional casters the additional height added by conventional casters is more pronounced or problematic.

One low profile caster 10 of the caterer buffet table conversion kit of the present invention includes a hollow tubular table coupling bracket 12, generally formed of steel, is configured to receive a conventional table leg therein to a floor of the bracket (generally at plane 28). A set screw 13 extends through the tube 12 and can be used to secure the low profile caster 10 to the leg 30.

A metal coupling arm 14 extends from the tube 12 to a caster mount 18 defining caster axis 16 about which a coupled caster frame 20 is mounted. A caster wheel 22 is mounted for rotation on an axle 24 secured to the caster frame 20. The caster frame 20 includes conventional caster wheel locks to secure a caster 10 and the associated table in place, in a known fashion.

The wheel 22 and axle 24 may also be formed as a conventional caster ball with lock, as known in the art. The caster mount 18, caster frame 20, caster wheel 22 and caster wheel axle 24 may be considered as the caster assembly. With the caster ball configuration the caster assembly would be formed of a caster mount, caster frame 20 and caster ball, with the center of the rotating caster ball being the equivalent of the wheel axle 24.

The hollow tubular table coupling bracket 12 is offset from the caster wheel 22 and configured to receive the table leg 30 therein such that the terminal end of the table leg 30 is positioned vertically below the center or axle 24 of the caster wheel 22 to minimize the height above the floor 26 introduced to the table top by the use of the caster 10. The end of the table leg 30 may extend farther than ½ of the radius of the caster wheel 22 (or this structural relationship may defined that the plane 28 is at a height above the ground 26 less than ½ the radius of the wheel 22) to minimize the table height.

Forming the steel tube construction for the hollow tubular table coupling bracket 12 extending above the centerline or axle 24 of the wheel 22 will allow that the tubular table coupling bracket 12 can easily accommodate the added torque introduced in the low profile caster 10 of the invention. The metal, preferably steel, coupling arm 14 connects the tubular table coupling bracket 12 to the caster mount 18 and the steel construction is also sufficient to withstand the loading requirements of the caster 10 with the associated table.

The set of four low profile table casters 10 component of the caterer buffet table conversion kit allows a caterer to easily convert a table without wheels to a table with them, without adding unwanted height to the table. This allows the table to be easily used as a buffet table and moved into and out of position with ease. Naturally the table is not restricted to use as a buffet table and can be used for seating guests or any conventional use. The sets of caster 10 obviously have independent utility, for example venue owners may wish to have sets of the casters 10 for all tables without the need for the extra pairs of handles 50.

### Straight Caster 10′

In some implementations the height of casters is not a concern and the desire is for a secure quick attaching caster, and for these applications a straight caster 10′ shown in FIG. 1B can be utilized effectively. The straight caster 10′ of the caterer buffet table conversion kit of the present invention includes a hollow tubular table coupling bracket 12′, generally formed of steel, is configured to receive a conventional table leg therein to a floor of the bracket 12′. A set screw 13 extends through the tube 12 and can be used to secure the caster 10′ to the leg 30.

In caster 10′, the tube 12′ is directly on and around caster mount 18 defining caster axis 16 about which a coupled caster frame 20 is mounted. A caster wheel 22 is mounted for rotation on an axle 24 secured to the caster frame 20. The caster frame 20 includes conventional caster wheel locks to secure a caster 10 and the associated table in place, in a known fashion.

The wheel 22 and axle 24 may also be formed as a conventional caster ball with lock, as known in the art. The caster mount 18, caster frame 20, caster wheel 22 and caster wheel axle 24 may be considered as the caster assembly. With the caster ball configuration the caster assembly would be formed of a caster mount, caster frame 20 and caster ball, with the center of the rotating caster ball being the equivalent of the wheel axle 24.

The 3″ hollow tubular steel table coupling bracket 12′ is vertically above the generally 3″ caster wheel 22 and configured to receive the table leg 30 therein. The set of four table casters 10′ component of the caterer buffet table conversion kit allows a caterer to easily convert a table without wheels to a table with them, where adding 4″ of height to the table is not concerning. This allows the table to be easily used as a buffet table and moved into and out of position with ease. Naturally the table is not restricted to use as a buffet table and can be used for seating guests or any conventional use. The sets of caster 10′ obviously have independent utility, for example venue owners may wish to have sets of the casters 10′ for all tables without the need for the extra pairs of handles 50.

### Spring Handles 50

The other component of the caterer buffet table conversion kit is the pair of detachable one piece spring handles 50, shown in FIGS. 2-5, for chafing pans (not shown) to assist in the manual transport and exchange of chafing dishes. A conventional chafing dish has a bottom panel and side walls extending upwardly there from defining a top opening, a top sealing flange ledge extends outwardly from the side walls around the entire periphery of the walls. The safety advantages of handles on chafing dishes and water pans is discussed above and in the prior art literature.

Each one piece spring handle 50 is formed from a one piece spring steel of about 3″-4″ wide and 0.8 mm-1.0 mm in thickness. Handles 50 in each of these thickness have been formed and are sufficient strength. The thickness needed will depend upon the strength of the specific steel, but 0.8 mm or 1.0 mm should be effective for most spring steels.

Each one piece spring handle 50 includes a semi-cylindrical grip 52 having a radius of about 13 mm around most of the grip until transitioning to an upper leaf and a lower leaf.

The lower leaf has a planar body member 52 extending from the semi-cylindrical grip 52 with the planar body member 52 immediately adjacent an upper leaf body member 60. The body members 52 and 60 may be riveted together or tack welded near the grip.

The lower leaf includes a bump-out member 56 which extends from the lower leaf body member 54 and is extending away from the upper leaf body member 60. A 3 mm radius curve may bend the bump out member 56 away from the upper leaf body member 60 and have the main portion of the bump-out member 56 formed with a 5 mm radius curve that transitions to an arcuate nose member 58.

The arcuate nose member 58 extends from the bump out member 56 and is adjacent an upper leaf transition member 62 or corner. The bump-out member 56 and arcuate nose member 58 configuration combine to provide the spring aspects to the handle 50. The arcuate nose member 56 and may be formed as a 7.5 mm radius curve. The bump-out member 56 and arcuate nose member 58 may be considered to form a spring forming member that engages the chafing pan between the upper and lower leaf.

The arcuate nose member of the lower leaf terminates in an end member which is positioned to angle away from an upper leaf end member 64 at about 60 degrees. The diverging end members allows for easy insertion of the ledge of a chafing pan into the handle 50.

The upper leaf is a general L shaped member extending from the semi-cylindrical grip 52 with the planar body member 60 extending from the semi-cylindrical grip 52 to the arcuate transition member 62 and terminating in the planar end member 64 which is substantially perpendicular to the body member 60. The length of the handle 60 is about 3″ from the end of the semi-cylindrical grip 52 along the upper leaf to the upper leaf end member 64.

In operation the ledge of the chafing pan is introduced in-between the diverging end members (64 and end of member 58) and advanced between the upper leaf and the lower leaf, with the bump-out member 56 and nose member 58 configuration allowing for the lower leaf to spring out and back to allow the ledge to be positioned between the planar body members 60 and 54 of the upper and lower leaf (away from the semi-cylindrical grip 52). The upper leaf end member 64 will lie along the sidewall of the chafing pan when the handle 50 is fully engaged. The handles 50 may be used in a conventional fashion to manually transport and exchange the food chafing pans when fully engaged.

The handles 50 may be pivoted 90 degrees to a non-engaged position with the ledge loosely gripped between the nose member 58 and the upper end member 64, such as for placing the chafing pans into a tight space for transport when the handles 50 are desired to remain with the chafing pan. In such circumstances, prior to manually moving the chafing pans, the handles 50 are pivoted to the fully engaged position.

The handles 50 provide a simple snap on and snap off attachment for conventional chafing dish pans and may be used by a single user for a number of chafing dish pans used in any event.

It will be apparent to those of ordinary skill in the art that various modifications may be made to the present invention without departing from the spirit and scope thereof. For example the handles 50 of FIGS. 2-5 could also be tack welded in place if movement between pans is no longer desired, however the above described releasable attachment is preferred for the advantages noted. The present invention is best defined by the appended claims and equivalents thereto.

What is claimed is:

1. A caterer buffet table conversion kit comprising
A) a pair of detachable one piece spring handles, wherein each one piece spring handle includes
a. a semi-cylindrical grip;
b. an upper leaf formed as an L shaped member extending from the semi-cylindrical grip with a body member extending from the semi-cylindrical grip to a transition member and terminating in an end member which is substantially perpendicular to the body member; and
c. a lower leaf having a body member extending from the semi-cylindrical grip with a body member immediately adjacent the upper leaf body member, and a spring forming member that is configured to facilitate the engagement of the chafing pan between the upper and lower leaf;
B) a set of four low profile casters wherein each caster includes
a. a caster assembly including one of a wheel on an axle or a caster ball, and with caster locks to secure a caster and table in place;
b. a tubular table coupling bracket coupled to the caster assembly and configured to receive a conventional table leg therein, wherein the tubular table coupling bracket is offset from the caster wheel or caster ball and configured to receive the table leg therein such that a terminal end of the table leg is positioned vertically below the center of the caster wheel or caster ball to minimize the height introduced to the table top by the use of the caster.

2. The caterer buffet table conversion kit according to claim 1 wherein each caster assembly includes a wheel on an axle.

3. The caterer buffet table conversion kit according to claim 2 wherein each tubular table coupling bracket of each low profile caster is configured to receive a conventional table leg therein such that a terminal end of the table leg is positioned less than ½ of the radius of the wheel above the ground.

4. The caterer buffet table conversion kit according to claim 3 wherein each tubular table coupling bracket of each low profile caster extends vertically above the wheel axle.

5. The caterer buffet table conversion kit according to claim 4 wherein each tubular table coupling bracket of each low profile caster includes a set screw configured to be engaged with the table leg.

6. The caterer buffet table conversion kit according to claim 1 wherein each one piece spring handle is formed from a one piece spring steel.

7. The caterer buffet table conversion kit according to claim 6 wherein the a spring forming member of each handle includes a bump-out member which extends from the lower leaf body member and is extending away from the upper leaf body member and an arcuate nose member which extends from the bump out member and is adjacent the upper leaf transition member.

8. The caterer buffet table conversion kit according to claim 7 wherein the lower leaf of each handle terminates in an end member of the nose member which nose member end member is positioned to angle away from the upper leaf end member.

9. A low profile caster comprising
a caster assembly including one of a wheel on an axle or a caster ball, and with caster locks to secure a caster and table in place; and
a tubular table coupling bracket coupled to the caster assembly and configured to receive a conventional table leg therein, wherein the tubular table coupling bracket is offset from the caster wheel or caster ball and configured to receive the table leg therein such that a terminal end of the table leg is positioned vertically below the center of the caster wheel or caster ball to minimize the height introduced to the table top by the use of the caster.

10. The low profile caster according to claim 9 wherein the caster assembly includes a wheel on an axle.

11. The low profile caster according to claim 10 wherein the tubular table coupling bracket is configured to receive a conventional table leg therein such that a terminal end of the table leg is positioned less than ½ of the radius of the wheel above the ground.

12. The low profile caster according to claim 11 wherein the tubular table coupling bracket extends vertically above the wheel axle.

13. The low profile caster according to claim 12 wherein the tubular table coupling bracket includes a set screw configured to be engaged with the table leg.

14. The low profile caster according to claim 9 wherein the tubular table coupling bracket is configured to receive a conventional table leg therein such that a terminal end of the table leg is positioned less than ½ of the radius of the caster wheel or caster ball above the ground.

15. The low profile caster according to claim 9 wherein the tubular table coupling bracket extends vertically above the wheel axle or center of the caster ball.

16. The low profile caster according to claim 9 wherein the tubular table coupling bracket includes a set screw configured to be engaged with the table leg.

17. A detachable one piece spring handle for a chafing dish comprising a semi-cylindrical grip;
an upper leaf formed as an L shaped member extending from the semi-cylindrical grip with a body member extending from the semi-cylindrical grip to a transition member and terminating in an end member which is substantially perpendicular to the body member; and
a lower leaf having a body member extending from the semi-cylindrical grip with a body member immediately adjacent the upper leaf body member, and a spring forming member that is configured to facilitate the engagement of the chafing pan between the upper and lower leaf.

18. The detachable one piece spring handle for a chafing dish according to claim 17 wherein the one piece spring handle is formed from a one piece spring steel.

19. The detachable one piece spring handle for a chafing dish according to claim 17 wherein the a spring forming member includes a bump-out member which extends from the lower leaf body member and is extending away from the upper leaf body member and an arcuate nose member which extends from the bump out member and is adjacent the upper leaf transition member.

20. The detachable one piece spring handle for a chafing dish according to claim 17 wherein the lower leaf terminates in an end member of the nose member which nose member end member is positioned to angle away from the upper leaf end member.
